(19) United States
(12) Patent Application Publication
(10) Pub. No.: US 2005/0080638 A1
(43) Pub. Date: Apr. 14, 2005

(54) Product marketing system and method

(76) Inventor: Geoffrey Maseruka, Ottawa (CA)

Correspondence Address: Ian Fincham;McFadden, Fincham, Suite 606, 225 Metcalfe Street, Ottawa, ON, K2P 1P9, CA

(21) Appl. No.: 10/681,916

(22) Filed: Oct. 10, 2003

(51) Int. Cl. G06F 17/60

(52) U.S. Cl. 705/1; 705/14

(57) ABSTRACT

The present invention relates to a system and method for marketing a product. The system includes a first subsystem for registration of suppliers of products and information with respect to the products; a second subsystem for registration of vendors with shelf space available to display the products and information with respect to available shelf space and associated fees; a third subsystem for the suppliers and vendors to negotiate for required shelf space, the supply and display of the products and payment of the fees. The first, second and third subsystems are all operably interconnected.

### BACKGROUND OF THE INVENTION

1. Field of the Invention

The present invention relates to a product marketing system and method and more particularly with an internet based product marketing system.

2. Prior Art

There are many challenges involved in product development and manufacturing. This is particularly true in the case of independent inventors or small companies where it is difficult to find the right individuals or companies who would be interested in the product. It would be a great advantage to have a place where the product could be displayed/available to be viewed and purchased by potential purchasers, and especially where the product could be displayed/offered for sale to a large number of potential purchasers.

Currently, many inventors of products utilize the services of marketing and licensing agents in an attempt to get their products on the market. Such services often cost thousands of dollars and do not provide any guarantees for the inventor.

The ultimate success of any product is dependent on the end users/purchasers and it is thus important to get the product to the end users where individuals and potential purchasers can actually view the product, touch and feel the product to determine whether, the product will satisfy their needs. It would be highly desirable if those interested in marketing a product or products could get the product(s) accessible to the potential user/purchaser in an economical fashion.

There are also many computer based systems for product development and marketing which are known. None, however, meet the needs of with respect to product display and marketing a easy and economical manner.

U.S. Pat. No. 6,542,871 (Harshaw) relates to a method for developing new products for introduction into the marketplace. This method involves the establishment of a plurality of pools where each pool is associated with a distinct subject matter, such as a general technology type or patent classification. Each pool is then a repository for new product ideas, concepts or partially developed products. One new product idea is then selected from the pool for further development. This selection is based on analysis with respect to marketability, patentability, technical feasibility. The selected product idea is then optimized and intellectual property protection acquired, then licensed to a manufacturer. A pool manager undertakes to identify and market the new product to potential licensees.

U.S. Published Patent Application 2002/004775 (Kossovsky et al.) relates to an online patent and licensing exchange system. The system enables potential licensees of patents and other intellectual property rights to transact licensing or assignment agreements with the inventors. There are three parts in the exchange system, a license market, an option market and a securitized asset cash flows market.

U.S. Pat. No. 6,044,354 (Asplen, Jr.) is concerned with a product planning system which uses a server for storing centralized data accessible by remote stations. The system provides for uniform product planning throughout an organization, while ensuring thoroughness, control and rapid implementation. It includes chapters on idea assessment, opportunity assessment, business plan, implementation planning and product launch which are all implemented by performing associated tasks customized according to each individual product.

U.S. Pat. No. 5,909,492 (Payne et al) relates to a network based sales system. Included within the system are at least one buyer computer, at least one merchant computer and at least one payment computer all connected by a computer network. The buyer computer is programmed to receive a user request for purchasing a product, and to cause a payment message to be sent to the payment computer, the payment message includes a product identifier. The payment computer is programmed to receive the payment message and to cause an access message to be created that comprises the product identifier and an access message authenticator based on a cryptographic key, and to cause the access message to be sent to the merchant computer. The merchant computer is programmed to receive the access message, to verify the access message authenticator and to cause the product to be sent to the user.

U.S. Pat. No. 6,574,608 (Dahod et al.) relates to a web-based system for connecting buyers and sellers. The system includes a website which is globally accessible by potential buyers and sellers. Potential buyers post descriptions of products and services which they desire onto the web site. Interested sellers of those products and services can access the descriptions posted by the buyers and selectively post responses to buyers. The system determines if the potential buyer retrieves a response directed to him from a potential seller and if so, it charges the potential seller a small fee.

### SUMMARY OF THE INVENTION

The present invention relates generally to a system for matching those wishing to have a product or products displayed and offered for sale to vendors who have available space to display the product(s). In one preferred embodiment, the system is a web based system where the website allows for suppliers to market their products directly to a user and/or to arrange for the display of their products at selected stores or vendors which are registered within the system.

In accordance with one embodiment of the present invention there is provided a system for marketing a product comprising: a first subsystem for registration of suppliers of products and information with respect to said products; a second subsystem for registration of vendors with shelf space available to display the products and information with respect to available shelf space and associated fees; a third subsystem for the suppliers and vendors to negotiate for required shelf space, the supply and display of the products and payment of the fees; wherein the first, second and third subsystems are operably interconnected.

In accordance with another embodiment of the present invention there is provided an internet based system for connecting an individual with a product available for sale to a store with space available to display that product and for marketing of the product. The system comprises: a first subsystem for cataloguing specifications of products and identification with respect to product contact persons; a second subsystem for registration of vendors having available shelf space to display the products, including dimensions of shelf space available, cost and vendor contact information; a third subsystem which includes means which permits the product contact persons to negotiate with the vendor for required shelf space; a fourth subsystem for direct purchase of the catalogued products; wherein all the subsystems are operably connected together and available through the internet.

In accordance with yet another embodiment of the present invention there is provided A method of marketing a product, comprising: (a) providing information on a product and a supplier of the product; (b) providing information on vendors with available shelf space to display the product, the information including information on available shelf space and cost of the shelf space; (c) negotiating with the vendors for desired shelf space, the supply and display of the product and payment for the display and sale of the products; (d) supplying the products to the vendors for display and sale; (e) accounting for the sale of the products by the vendors; and (f) providing supplier with a predetermined percentage of the sales.

Having thus generally described the invention, reference will now be made to the accompanying drawings.

### BRIEF DESCRIPTION OF THE DRAWINGS

FIG. 1 is a block diagram illustrating the apparatus of the product marketing system of the present invention;

FIG. 2 is a block diagram illustrating the main menu of the product marketing system of the present invention;

FIG. 3 is a schematic illustration representing the inventors/suppliers registration section;

FIG. 4 is a schematic illustration representing the suppliers account section;

FIG. 5 is a block diagram illustrating the vendor registration section;

FIG. 6 is a block diagram illustrating the vendor account section;

FIG. 7 is a block diagram illustrating the direct sales section;

FIG. 8 is a block diagram illustrating the information and contents section;

FIG. 9 is a block diagram illustrating the products section.

### DETAILED DESCRIPTION OF THE INVENTION

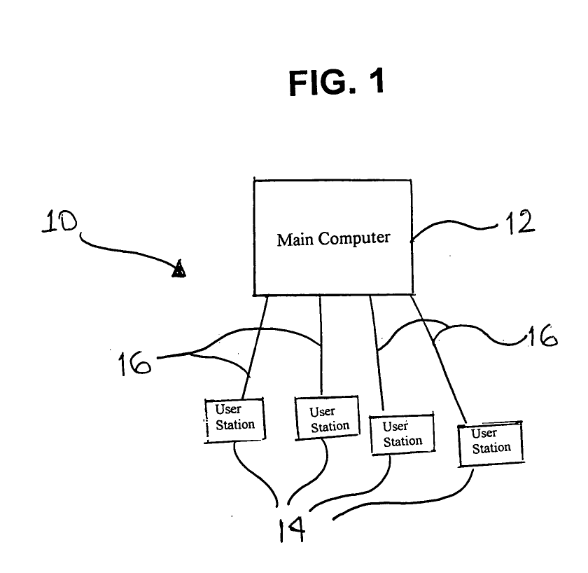

FIG. 1 illustrates a basic apparatus for implementing the system of the present invention. The preferred apparatus 10 includes a main computer 12 which includes databases for storage of information. The main computer 12 is accessible by a plurality of user stations 14, which may be in the form of personal computers, which user stations are capable of connection with the main computer 12 through communication means 16, such as any known internet connection means.

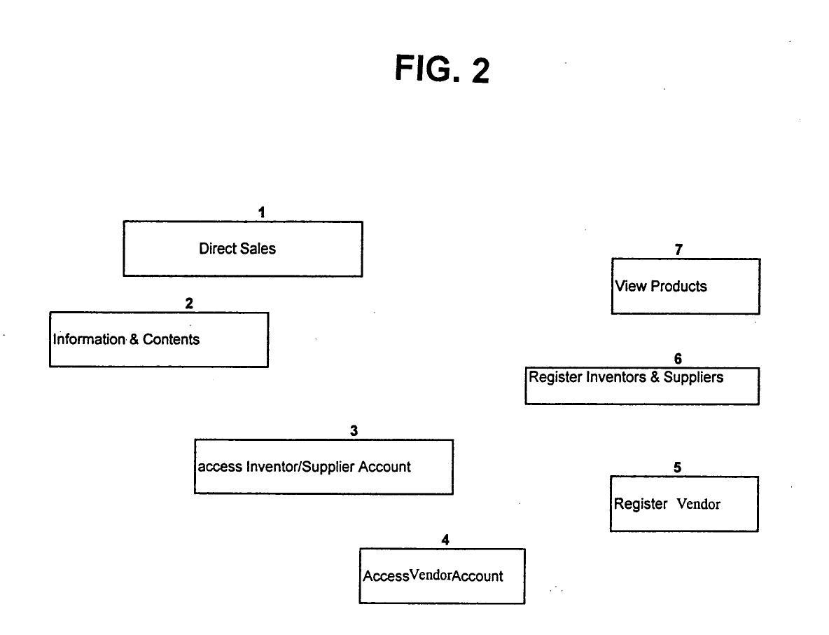

When the main computer 12 is accessed by a user, through a user station 14, the user will be able to access the system of the present invention through a website which will include a main menu, as shown in FIG. 2. The main menu includes a plurality of options for the user, designated by reference characters 1 to 7. The various options 1 through 7 relate to different subsections or chapters of the system. Included within the main menu could be options relating to a “Direct Sales” section 1, “Information and Contents” section 2, “Access Inventor/Supplier Account” section 3, “Access Vendor Account” section 4, “View Products” section 5, “Register Inventors/Suppliers” section 6 and “Register Vendors” section 7.

The various sections will be described hereinafter briefly and will be described in more detail with reference to the particular figures.

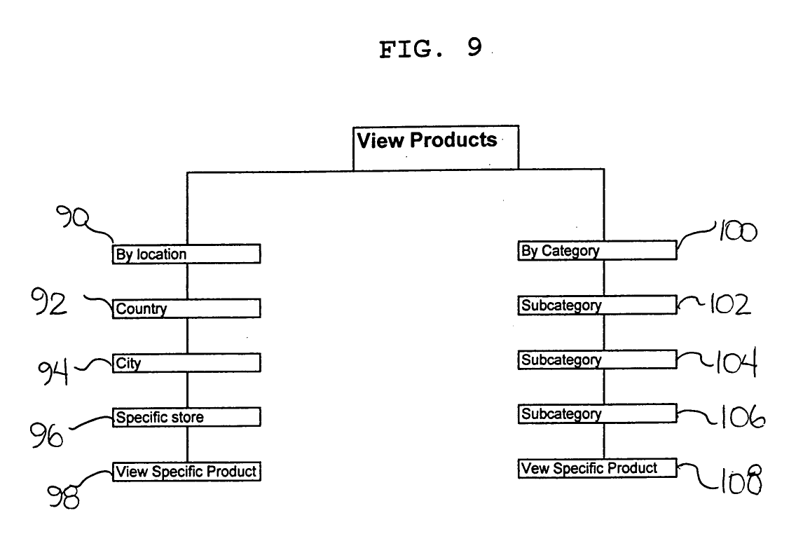

In general, through the website of the present system, a user will be able to read about the business in the Information and Contents section 2. This section will provide potential users with the advantages and benefits of the system of the present invention. A user will also be able to view products registered within the system through section 7. The set up of this section will enable a user to view products by category or location as will be discussed hereinafter with reference to FIG. 9. The registration by inventors or suppliers chapter 6 will enable the registration of information provided by the supplier of the product(s). Section 5 will permit the registration of store operators or vendors with the provision of required information in designated fields. Section 3 will enable product suppliers to access their accounts utilizing username and passwords. Likewise, Section 4 will enable vendors to access their account utilizing username and passwords. Section 1 will enable individuals to purchase registered products directly from the website.

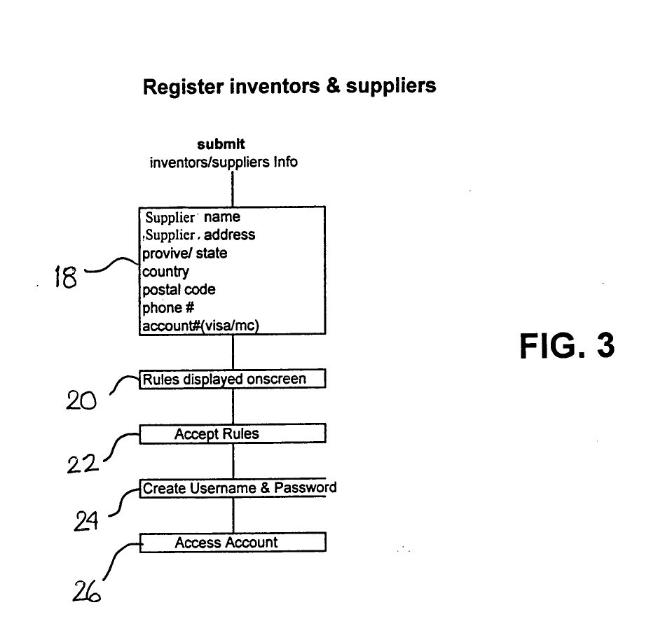

Reference will now be made in more detail to FIGS. 3 through 9 which illustrate the various options or sections 1 through 7 of the main menu in describing the system and method of the present invention.

FIG. 3 illustrates the supplier registration section/chapter of the present invention. The supplier could be an inventor or other person or entity who has a product they are interested in having displayed for potential sale. All suppliers wishing to utilize the system of the present invention will have to register on the website. All registered information will be stored and maintained in databases in the main computer 12. On registration, all suppliers will be required to submit general information 18, which includes but is not limited to supplier's name, email address, product category, any patent information (including patent/application numbers, issue/filing/publication dates), payment information (such as bank account number or credit card number), and any relevant health and safety certification data.

The supplier will then be provided with rules and or terms of use of the system at 20 which will be displayed onscreen at the user station 14. Such rules or terms of use will be set by the website provider and will be discussed hereinafter in greater detail. The supplier after reviewing and understanding the rules or terms of use will then be given the option of accepting the rules at 22 and proceeding with registration, or alternately, the supplier can at this time, if not in agreement with the rules, exit the system.

After entering this general information at 18 and accepting the rules for use of the system at 22, the supplier will be required to create a username and password at 24 for the supplier's account. The supplier will then be assigned a registration number and will have access to the account at 26.

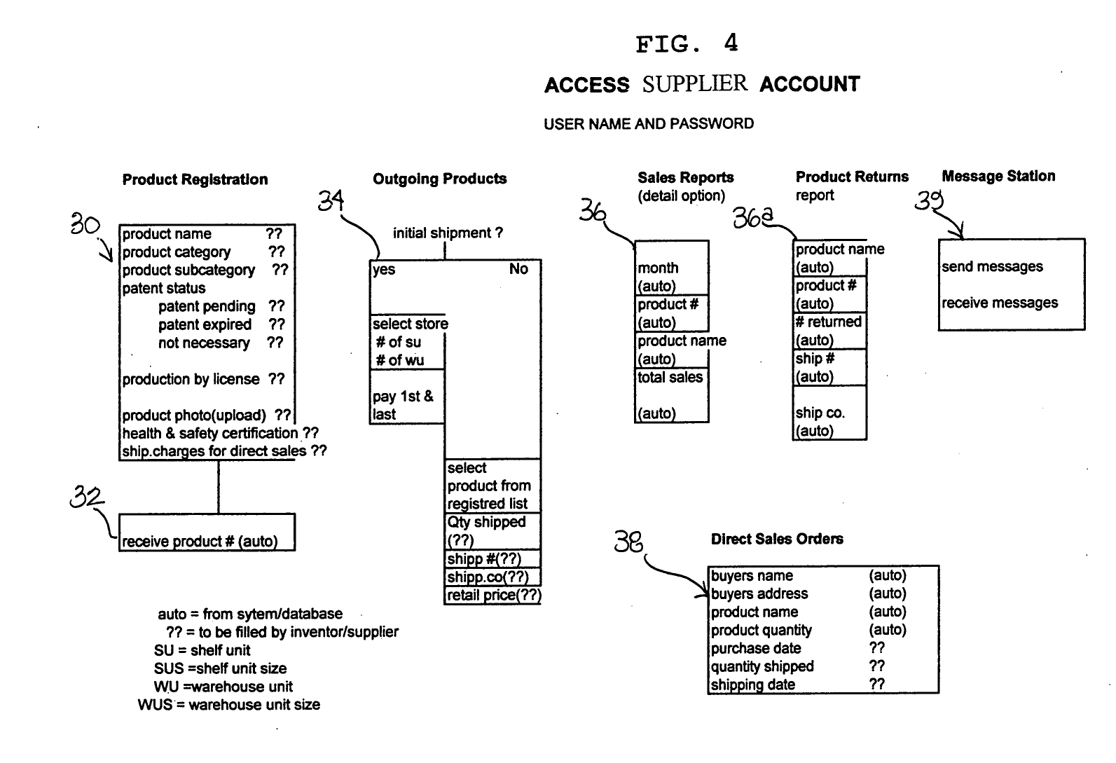

Referring now to FIG. 4, the supplier can access the supplier account where the supplier will then be required to register the product in question by providing product information at 30. The product information will include, but not be limited to product category, product description, product photo, patent status, patent ownership information, product health and safety certification information, and shipping charges for direct sales. Under the product health and safety certification, any certification numbers could be provided or alternately there could be the capability of uploading a copy of the actual certificate. Encompassed within the shipping section could be the provision of a fixed shipping charge chart for different quantities/shipping locations. Alternately, a link could be provided to a desired shipping company which could provide instant quotes for different locations/package sizes.

After the supplier provides all the required product information, the website will provide a unique product number at 32 for the product.

Once a product number is received, and the supplier duly registered, the supplier will be in a position to ship the product to a desired vendor as will be discussed in more detail hereinafter.

Before shipping the product to the vendor, the supplier will have to ensure that there is space available within a vendor premises. In this regard, every vendor will be required to have a shelf unit size (SUS). The shelf unit size will specify the cubic feet/meters available in one unit of shelf space. Each vendor will be entitled to set its own SUS and the maximum number of units available. Vendors could also be allowed to set the maximum number of available units for each product, or alternately, this value could be set by the website provider. Suppliers will then be allowed to purchase or rent a predetermined maximum number of units per product.

The supplier will access the shipping or outgoing product subsection 34 of the account. In this section, the supplier will select the country, state/province, city and a specific vendor. The supplier will proceed to select the number of shelf units required. At this point the supplier will be required to pay first and last months rent for the shelf units desired in order to reserve the shelf space. The next step is to ship the product in the quantity that fits in the shelf space purchased. The shipping information has to be recorded on the website (shipping company, shipping number, weight of shipment (kg/lb). The supplier will have to select the product being shipped (some suppliers may in fact have several products), the retail price for the product, etc. To ensure easy identification of the packages shipped, the supplier can utilize the product registration number on the packages being shipped.

The supplier will be able to access in the supplier account a row of data representing the product (product name, product number, quantity shipped, shipping company, shipping number, shelf units allocated to the product, product price, etc.).

As illustrated in FIG. 4, there is also provided a section for direct orders from internet customers at 38. Customers will be able to order product directly from the supplier. In this section 38, the supplier will be able to see the information provided by the customer from a user station 14 including but not limited to customer name, address, product name, product number, quantity required, product price and shipping charges). The supplier will ship the product to the customer and provide the information about the shipment on the website (such as shipping date, weight (kg/lb), shipping company, bill number). The shipment is complete only after all of the shipment information is provided.

The suppliers account will also contain a messaging subsection 39. This subsection will enable the website providers to send information and announcements to the suppliers. The suppliers will be able to send information (complaints and recommendations) to the website providers via this messaging subsection. Suppliers will also be able to send messages to vendor operators about changes to the product, or other details and information.

The suppliers account will also contain a sales and inventory section 36, 36a. This section will display the sales, sales returns, product price, beginning inventory, ending inventory, cash deposits, etc.

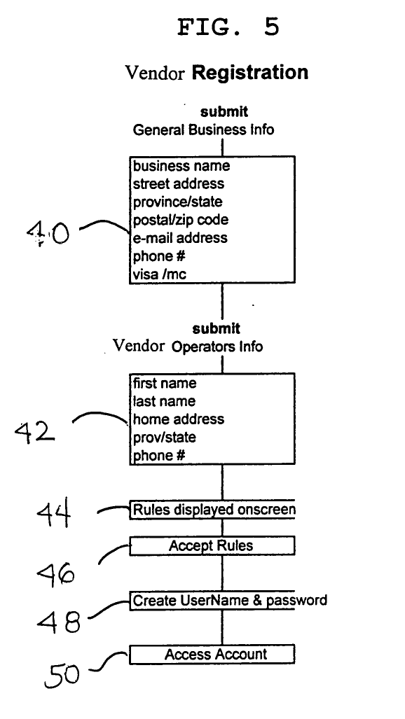

Referring now to FIG. 5, this figure depicts the vendor registration section of the system of the present invention. In a similar manner to the supplier registration noted hereinabove, vendors will be required to register general business information at 40 with respect to the vendor, including, but not limited to, vendor name, address, phone number, category (type of vendor, i.e. video store, dollar store, department store, etc.), size of vendor premises, email address, bank account or credit card information. The next step or phase of the registration process involves the registration of general information pertaining to the vendor at 42, such as full name, address, phone number, email, etc.

Once the required information is provided, the rules or terms of use for vendors will be displayed at 44. The vendor will then be given the option to accept the terms/rules of use at 46 or not. If the vendor operator chooses not to accept the rules or terms of use, the system will then be exited.

Assuming the vendor accepts the rules/terms of use at 46, the vendor will be asked to provide a user name and password at 48. Once this is provided, the vendor will have access to the vendor account at 50.

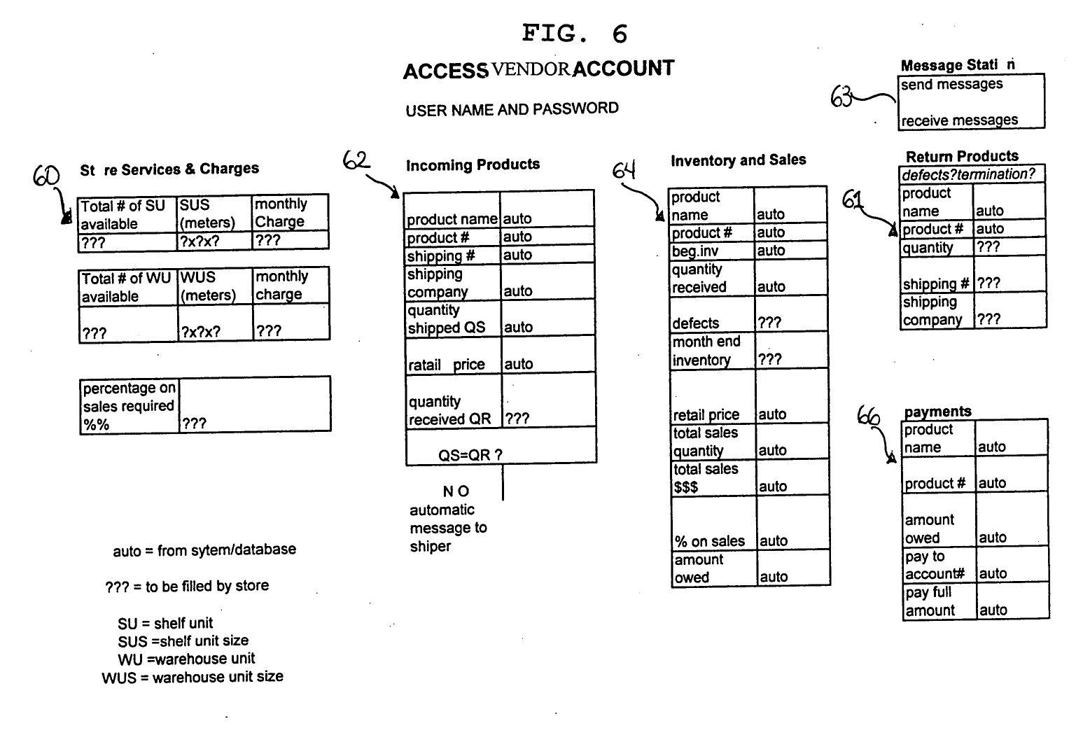

With reference to FIG. 6, once the vendor account is created, the vendor will provide further information with respect to vendor services and charges at 60. Such information could include information on shelf units available to display product, shelf unit size (SUS), warehouse units available, warehouse unit size (WUS), monthly charge, required percentage on sales, etc.

Initially, it is desirable that the vendor be required to use standard settings for shelf unit size (SUS) or warehouse unit size (WUS), monthly charges and percentage on sales. This standards could be set by the website provider. After some time, vendors will have the right to change these settings to their own benefit. A change in the settings will trigger the website to automatically send messages to suppliers notifying them about the coming changes. The vendors are required to give suppliers an advance notice, such as an advance notice of two full calendar months, prior to any changes.

All new products should arrive at the vendor's premises a predetermined number of days before the beginning of the month. This predetermined number of days could be set by the website provider initially, and may be, for example 5 or 10 days before the beginning of the month. Of course this time period could vary considerably depending on vendor requirements. Having the product available prior to the beginning of the month enables the vendor time to process the packages. After receiving the packed product, the vendor has to access his account.

The vendors account will have a receiving subsection 62. In this section, the vendor will view the products shipped to the store from different suppliers. Vendors will see the following: product number, product name, shipment date, shipment number, product price. The vendor will identify the package by the product number on the box. This product number will be matched with product numbers shipped. The shipment number on the package may also be matched to that on the box. The vendor will verify the quantity of the products received. The receiving process is completed by filling a number in the quantity received column. This will automatically update information. If the shipping quantity does not match the received quantity an automatic message will be sent to the supplier. This automatic message will include the store number, product number, quantity shipped, and quantity received.

The vendors account will also include a sales and inventory section 64. At the end of each month, vendors will be required to count each product and fill the quantity in the ending inventory column. The vendors will also fill in the quantity of returned products. After filling in the quantities, the system will automatically calculate the sales in dollars: (beginning inventory+product received−product returns−end inventory)×product price=total sales. The system will also automatically display the sales percentage to be received by the store (in dollars) and the amount due to the supplier.

The vendors account will also contain a message subsection 63. This subsection will display information from suppliers and the website provider. The vendor will be able to send messages to suppliers and to the website provider.

There will also be provided in the store account, a payment section 66. This payment section will calculate the amount due to each account for each product. In this section 66, the vendor will be able to select the accounts he wishes to pay and the amount to be paid.

Also included is a return products section 61. This section 61 is designed in preferred forms to allow the vendor to return products to the supplier. In this regard, products may be returned for any number of reasons. In some cases, products may be seasonal in nature, such as for example ice hockey gear, fishing equipment, etc. Before the end of the season, the suppliers can be given the option of reducing the price for these products (sale) or having the products returned to them at the end of the season (if the supplier opts to reduce the price, the supplier will be able to change the retail price in the suppliers account noted in FIG. 4). Defective or damaged products can also be returned to the supplier. Still further, at some point, the supplier might feel that a particular vendor is not providing the expected sales. The supplier could then terminate the credit card payments for the SUS/WUS. Such action will send a message to the vendor requiring the vendor to ship the remaining product back to the supplier.

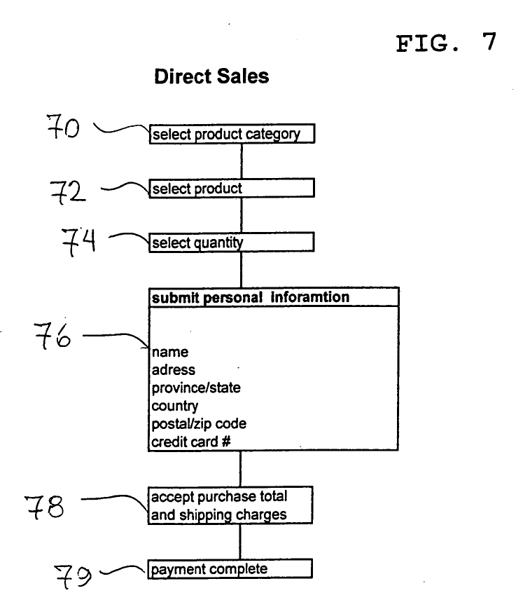

Referring now to FIG. 7 relating to the direct sales section, this section will enable direct purchases by a user from the supplier. Direct purchasers will be able to select a product by category at 70, select a product at 72, select quantity at 74, provide name and address information at 76, accept price and shipping charges at 78 and provide credit card information at 79 to purchase product.

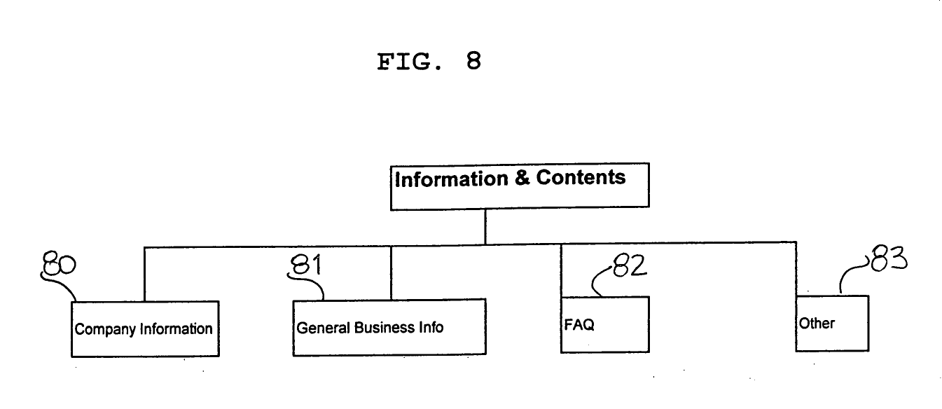

FIG. 8 shows the information and contents section of the present system. In this section, users will be able to access details as to company information at 80, general business information 81, facts about the business at 82 and other information which may be posted with respect to the system of the present invention at 83.

FIG. 9 illustrates the Products section which will enable users to view all of the products registered on the website. The products section includes a plurality of options by which a user can view products by location at 90 or by category at 100. Subsections under location 90 could include country 92, city 94, specific store 96 and specific product 98. Subsections under category 100 could include various subcategories 102, 104 and 106 and also the option to view a specific product at 108.

The website will be maintained by the website provider. The website provider can verify information provided by the suppliers/stores registered to add value and trust to the system and protect the integrity of the system.

The identity and authenticity of the supplier or vendors can be verified with different types of software and technologies. Suppliers and store owners may be required to use electronic signatures in order to authenticate information provided. It is also possible to sign online documents with hand written signatures on electronic pads.

Suppliers and vendors may be further required to provide audio or video records. This means that suppliers and vendors might have to read a message in front of a video camera or use a microphone to record. This message would then be recorded directly onto the database of the system.

Many other known methods can be used to identify the users of the system. This will eliminate abuse of the system.

The rules and terms of use of the site will be set by the website provider. The specific rules for a vendor, could include the following
a) The store is responsible for the creation and changes to the SUS and WUS and the respective fees. Stores may change the size of the SU or WU and the respective fees with a notice of one month.
b) The store is responsible for the selection of a percentage on sales.
c) The website provider will retain a percentage of the monthly fees (with a minimum charge) and percentage on sales. The store may waive the monthly fees.
d) All incoming products must be placed in the proper unit size among products of like category
e) Defective products and termination inventory will be sent back to the supplier cash on delivery (COD).
f) The store must notify the supplier of an impending closure three months in advance.
g) The store must enter month end inventory of all products. All month end inventory should be conducted during the last 5 days of the month.
h) All amounts owing must be paid in one payment within the first 5 days of the month.
I) The store is responsible for the information provided.
j) The website provider may withdraw the store.
k) The website provider is not liable for lost profits or damages.
l) The website is provided by the website provider without any warranties.

The rules and terms of use applicable to an supplier could include, but not be limited to:
a) All products must be properly packaged and sealed with expiry dates where necessary.
b) All products should have a bar code and all shipped goods must fit within the dimensions of the SUS (WUS) purchased. Excess product will not be allowed.
c) All suppliers must have the legal right to sell the products (patents, licenses, etc.).
d) All initial shipments must arrive at the store 10 days before the first of the month.
e) All defective products will be received cash on delivery (COD).
f) Suppliers may terminate the distribution of a product at any time by stopping the monthly deductions from their account. This option entitles the supplier to the last months paid. At the end of the last paid month the closing-termination inventory will be returned to the supplier COD.
g) The supplier agrees to pay a fixed monthly charge as specified by the store. A percentage (15%) of the fixed monthly charge will be retained by the website provider. The supplier agrees to pay a minimum charge as specified by the website provider if and when the monthly fees are waived by the store.
h) The supplier agrees to pay a percentage on sales as specified by the store and the website provider (1%).
i) The supplier may change the retail price with a notice of one full calendar month.
j) The supplier is responsible for the information provided.
k) The website provider may withdraw your product.
l) The website provider is not liable for lost profits or damages.
m) The website is provided without any warranties by the website provider;
n) All suppliers must be 18 years of age or older.

The website provider can also set initial default parameters as to fees and SUS/WUS dimensions. During the first few months of operations, the website provider will require all stores to use the default parameters. An example of the typical default parameters which could be set are as follows:
SUS=0.4 m×0.4 m×0.6 m Monthly fees—$15.00
WUS=1 m×1 m×1 m Monthly fees—$50.00
Percentage on Sales 7%
   Website provider fees:
15% SUS Monthly fees
2% on Sales.
   Of course, it will be appreciated that any default settings could be utilized at the discretion of the website provider.

Offline software could be provided to registered suppliers and vendors which would permit these users to download their accounts onto a CD or computer. The software would enable the users to complete all their transactions offline. After completing their transactions they will be required to link up to the website. Linking to the website will update the users account and at the same time the users account will update the website. This option will reduce the number of individuals logged onto the website.

The website provider can receive a certain percentage of the revenue generated by the website. If desired, the amount payable to the website provider could be a certain percent of the SUS monthly fees and/or a certain percent of sales. Alternately, the website provider may set fees which are payable on registration by suppliers/vendors.

It will be understood that various variations and modifications can be made to the system of the present invention without departing from the concept and spirit of the invention.

1. A system for marketing a product comprising:
a first subsystem for registration of suppliers of products and information with respect to said products;
a second subsystem for registration of vendors with shelf space available to display said products and information with respect to available shelf space and associated fees;
a third subsystem for said suppliers and vendors to negotiate for required shelf space, the supply and display of said products and payment of said fees;
wherein said first, second and third subsystems are operably interconnected.

2. The system as claimed in claim 1, wherein said system is a web based system and said subsystems are operably interconnected through the internet.

3. The system as claimed in claim 1, further comprising a fourth subsystem for direct sales of said products.

4. The system as claimed in claim 2, wherein said system is maintained by a web provider.

5. The system as claimed in claim 1, further comprising a fifth subsystem for viewing registered products.

6. The system as claimed in claim 5 wherein said fifth subsystem permits the viewing of registered products by location and category.

7. The system as claimed in claim 1, wherein said first subsystem includes an account section for maintaining account of products shipped, cost of shelf space, and sales information.

8. The system as claimed in claim 1, wherein said second subsystem includes an account section for maintaining account of incoming products, inventory and sales, and payments.

9. The system as claimed in any claim 1, wherein said first and second subsystems further including messaging systems to permit vendors and suppliers to send messages to each other.

10. A method of marketing a product, comprising:
(a) providing information on a product and a supplier of said product;
(b) providing information on vendors with available shelf space to display said product, said information including information on available shelf space and cost of said shelf space;
(c) negotiating with said vendors for desired shelf space, the supply and display of said product and payment for the display and sale of said products;
(d) supplying said products to said vendors for display and sale;
(e) accounting for the sale of said products by said vendors; and
(f) providing supplier with a predetermined percentage of said sales.

11. The method of claim 10 which is web based.

12. The method of claim 10, further comprising:
providing for direct web based sales of said product.

13. An internet based system for connecting an individual with a product available for sale to a store with space available to display that product and for marketing of said product, said system comprising:
a first subsystem for cataloguing specifications of products and identification with respect to product contact persons;
a second subsystem for registration of vendors having available shelf space to display said products, including dimensions of shelf space available, cost and vendor contact information;
a third subsystem which includes means which permits said product contact persons to negotiate with said vendor for required shelf space;
a fourth subsystem for direct purchase of said catalogued products;
wherein all said subsystems are operably connected together and available through the internet.

14. The internet based system of claim 13, wherein said system is maintained by a webprovider.

15. The internet based system of claim 13, further comprising a fifth subsystem for viewing of registered products by location and category.

16. The system of claim 1, wherein said first subsystem includes a supplier registration section and an supplier account section.

17. The system of claim 1, wherein said second subsystem includes a vendor registration section and a vendor account section.

18. The system of claim 16, wherein said supplier registration section of said first subsystem includes a first section for supplier registration information, a second section for rules of use, a third section which generates username and password information for said supplier.

19. The system of claim 17, wherein said vendor registration section includes a first section for vendor registration information, a second section for rules of use and a third section which generates username and password information for said vendor.

20. The system of claim 16, wherein said supplier account section includes a product information section, outgoing product section, sales report section, product returns section, direct sales order section and a messaging section.

21. The system of claim 17, wherein said vendor account section includes a services and fee section; incoming product section, inventory and sales section, return products section, payment section and a messaging section.
